(19) United States
(12) Patent Application Publication
(10) Pub. No.: US 2023/0076126 A1
(43) Pub. Date: Mar. 9, 2023

(54) DEVICE TO DEVICE COMMUNICATION MECHANISM FOR DIFFERENT OPERATORS SUBSCRIBERS

(71) Applicant: AT&T Intellectual Property I, L.P., Atlanta, GA (US)

(72) Inventor: Sreejith Menon, Herndon, VA (US)

(21) Appl. No.: 17/465,071

(22) Filed: Sep. 2, 2021

(51) Int. Cl. H04W 8/12; H04W 8/28; H04W 8/00

(52) U.S. Cl. CPC H04W 8/12; H04W 8/28; H04W 8/005; H04W 92/18

(57) ABSTRACT

A system in which a device to device (D2D) communication may be enabled between not just the same cellular providers subscribers but also with subscribers who are from different cellular providers in a region. The system may provide D2D communication interoperability and roaming.

### BACKGROUND

A public safety user equipment (UE) at the cell edge or in a disaster-hit area may encounter poor or no radio signal quality while attempting to connect to the E-UTRAN network. A proximity service (ProSe) enabled UE today can communicate to other ProSe enabled UE, that belong to the same operator. This is because a spectrum license in an area belongs to only 1 operator. However, if two UE's from different carriers want to communicate with each other it becomes a challenge.

This background information is provided to reveal information believed by the applicant to be of possible relevance. No admission is necessarily intended, nor should be construed, that any of the preceding information constitutes prior art.

### SUMMARY

A system is described whereby a device to device (D2D) communication may be enabled between not just the same cellular providers subscribers but also with subscribers who are from different cellular providers in a region. The system may provide D2D communication interoperability and roaming.

In an example, an apparatus may include a processor and a memory coupled with the processor that effectuates operations. The operations may include sending, by a first user equipment (UE), a discovery message to discover user equipment proximate to the first UE; receiving an authentication message from a second UE; determining there is a match for an International Mobile Subscriber Identity (IMSI) of the second UE with an inbound roam allowed IMSI list of the first UE; and based on the match, establishing a D2D communication link between the first UE and the second UE. The apparatus may be the first UE.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

Reference will now be made to the accompanying drawings, which are not necessarily drawn to scale.

FIG. 1A illustrates an exemplary system for device to device (D2D) communication.

FIG. 1B illustrates an exemplary system for device to device (D2D) communication.

FIG. 2A illustrates an exemplary method for device to device (D2D) communication.

FIG. 2B illustrates an exemplary method for device to device (D2D) communication.

FIG. 3 illustrates a schematic of an exemplary network device.

FIG. 4 illustrates an exemplary communication system that provides wireless telecommunication services over wireless communication networks.

### DETAILED DESCRIPTION

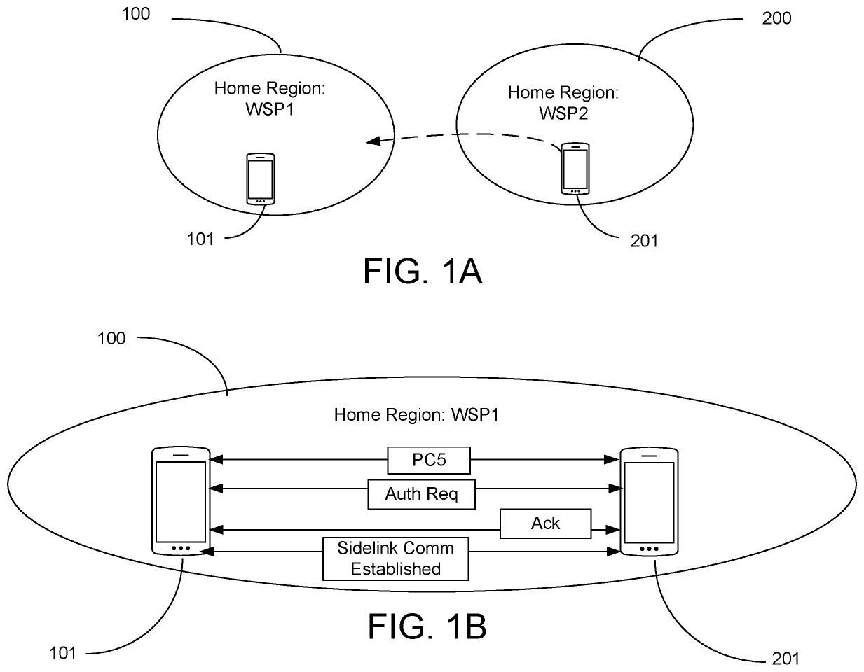

FIG. 1A illustrates an exemplary system for device to device (D2D) communication (also includes proximity services). Home region 100 (also referred herein as home region A) may a plurality of user equipment that communicates with each other on a band X, such as UE 101. Home region 200 (also referred herein as home region B) may include a plurality of user equipment that communicates with each other on a band Y, such as UE 201. Home region 100 may be for a first wireless service provider (WSP) and home region 200 may be for a second WSP. There may be a scenario, as further described herein, in which UE 201 and UE 101 are in the same home region (e.g., home region 100).

FIG. 1B illustrates an exemplary system for device to device (D2D) communication. As shown, UE 101 and UE 201 are now in home region 100 (i.e., home region A) and based on the method as described herein may communicate using D2D communication, although serviced by different wireless service providers. In this scenario, UE 101 is the home UE, while UE 201 is the visited UE. Table 1 shows an exemplary table located within UE 101, in which UE 201 may store a similar table.

TABLE 1
UE 101

| | Inbound Roam | Outbound Roam |
|---|---|---|
| Home IMSI | Allowed IMSI | Allowed IMSI |
| 111-111 (WSP 1) | 222-222 (WSP 2) | 111-222 (WSP 3) |
| | 111-222 (WSP 3) | 222-222 (WSP 2) |
| | 111-333 (WSP 4) | |

Table 1 may be described as follows. The first column is for the Home International Mobile Subscriber Identity (IMSI) which is the home network for wireless coverage for UE 101, such as 111-111. The second column is for the inbound roam allowed IMSI for UE 101. UE 101 may allow three different service providers: 222-222 (e.g., WSP 2), 111-222 (e.g., WSP 3), or 111-333 (e.g., WSP 4). UE 101 may allow any roaming device with Home Mobile Country Code (MCC)-Mobile Network Code (MNC) (IMSI) 222-222, 111-222, 111-333 to authenticate and enable D2D communication with those devices (e.g., UE 201) and UE 101. The third column is for the outbound roam allowed IMSI for UE 101. UE 101 may allow two different service providers: 222-222 (e.g., WSP 2) or 111-222 (e.g., WSP 3). UE 101 may discover and try to authenticate with other devices that have MCC-MNC (Home IMSI) of 111-222 or 222-222. For the outbound roam, UE 101, may only send authentication request message if a device is recognized to belong to the listed MCC-MNC. It is contemplated herein that another identifier other than an IMSI may be used. It is also contemplated that roaming agreements (e.g., bilateral or unilateral) may be setup between service providers and the tables (e.g., Table 1) may be remotely updated on the UEs whenever connected with a base station.

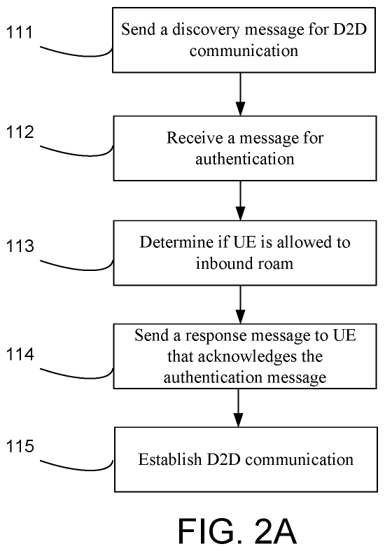

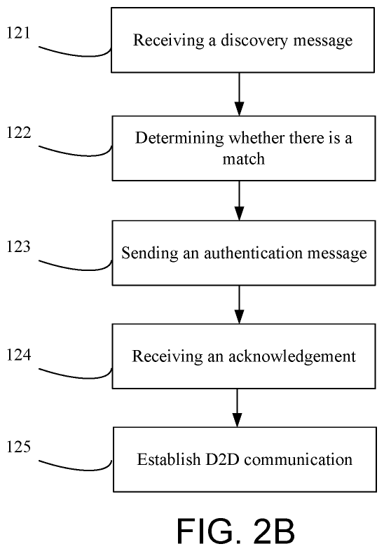

FIG. 2A illustrates an exemplary method for D2D communication. At step 111, UE 101 may send a discovery broadcast message to discover UE's in its vicinity. UE 201 may monitor for messages (e.g., monitor on the PC5 link for Relay Discovery Additional Information—RDAI). When UE 201 receives a matching MCC-MNC (e.g., E-UTRAN cell global Identifier—ECGI) to its outbound roam allowed IMSI (which may be found in the SIM or another part of UE 201), an authentication mechanism is triggered in UE 201.

At step 112, UE 101 may receive a message for authentication in ProSe communication with UE 201.

At step 113, in response to receiving the message of step 112, UE 101 may determine if UE 201 is allowed to inbound roam. UE 101 may determine this by checking its list for inbound roam allowed IMSI, which may be located in the SIM of UE 101) with MCC-MNC of UE 201. The MCC-MNC of UE 201 may be located in the received message of step 112.

At step 114, when there is a match of the MCC-MNC, UE 101 may send a response message to UE 201 that acknowledges the authentication message (an authentication request) of step 112.

At step 115, based on or subsequent to the acknowledgment of the authentication request, a sidelink PC5 may be established between UE 101 and UE 201.

FIG. 2B illustrates a method that may be from UE 201. At step 121, UE 201 receives a discovery message from UE 101, which is in proximity to it. At step 122, UE 201 determines whether there is a match of the IMSI of UE 101 with the outbound allowed roam IMSI. At step 123, based on the match, sending an authentication message to UE 101. At step 124, in response to sending, receiving an acknowledgement from UE 201. At step 125, establishing a D2D communication link between UE 201 and UE 101.

Conventionally on the cellular network MCC-MNC may be used for triggering roaming and involves the use of an HSS which does authentication. The disclosed subject provides methods, systems, and apparatuses for roaming in D2D communication with UEs of different providers. The disclosed system and method are not needed or considered in conventional systems and allows for roaming without the use or connection to a wireless carriers base station. As disclosed, a discovery (e.g., RDAI) message may be used to derive the MCC-MNC and then to acknowledge roaming. The disclosed system provides an authentication mechanism when there is D2D communication with devices that have different SIM cards (e.g., different carriers).

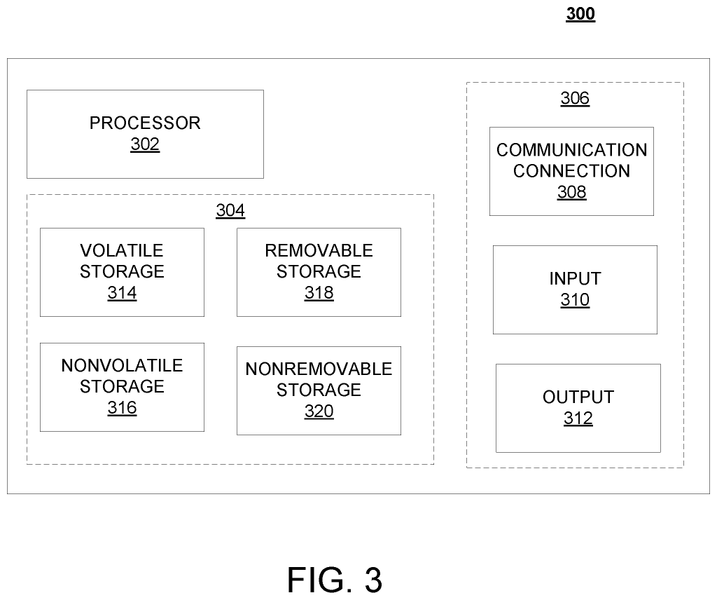

FIG. 3 is a block diagram of network device 300 that may be connected to or comprise a component of FIG. 1A or FIG. 1B (e.g., UE 201 or UE 101). Network device 300 may comprise hardware or a combination of hardware and software. The functionality to facilitate telecommunications via a telecommunications network may reside in one or combination of network devices 300. Network device 300 depicted in FIG. 3 may represent or perform functionality of an appropriate network device 300, or combination of network devices 300, such as, for example, a component or various components of a cellular broadcast system wireless network, a processor, a server, a gateway, a node, a mobile switching center (MSC), a short message service center (SMSC), an automatic location function server (ALFS), a gateway mobile location center (GMLC), a radio access network (RAN), a serving mobile location center (SMLC), or the like, or any appropriate combination thereof. It is emphasized that the block diagram depicted in FIG. 3 is exemplary and not intended to imply a limitation to a specific implementation or configuration. Thus, network device 300 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Network device 300 may comprise a processor 302 and a memory 304 coupled to processor 302. Memory 304 may contain executable instructions that, when executed by processor 302, cause processor 302 to effectuate operations associated with mapping wireless signal strength.

In addition to processor 302 and memory 304, network device 300 may include an input/output system 306. Processor 302, memory 304, and input/output system 306 may be coupled together (coupling not shown in FIG. 3) to allow communications between them. Each portion of network device 300 may comprise circuitry for performing functions associated with each respective portion. Thus, each portion may comprise hardware, or a combination of hardware and software. Input/output system 306 may be capable of receiving or providing information from or to a communications device or other network entities configured for telecommunications. For example, input/output system 306 may include a wireless communications (e.g., 3G/4G/GPS) card. Input/output system 306 may be capable of receiving or sending video information, audio information, control information, image information, data, or any combination thereof. Input/output system 306 may be capable of transferring information with network device 300. In various configurations, input/output system 306 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 306 may comprise a Wi-Fi finder, a two-way GPS chipset or equivalent, or the like, or a combination thereof.

Input/output system 306 of network device 300 also may contain a communication connection 308 that allows network device 300 to communicate with other devices, network entities, or the like. Communication connection 308 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 306 also may include an input device 310 such as keyboard, mouse, pen, voice input device, or touch input device. Input/output system 306 may also include an output device 312, such as a display, speakers, or a printer.

Processor 302 may be capable of performing functions associated with telecommunications, such as functions for processing broadcast messages, as described herein. For example, processor 302 may be capable of, in conjunction with any other portion of network device 300, determining a type of broadcast message and acting according to the broadcast message type or content, as described herein.

Memory 304 of network device 300 may comprise a storage medium having a concrete, tangible, physical structure. As is known, a signal does not have a concrete, tangible, physical structure. Memory 304, as well as any computer-readable storage medium described herein, is not to be construed as a signal. Memory 304, as well as any computer-readable storage medium described herein, is not to be construed as a transient signal. Memory 304, as well as any computer-readable storage medium described herein, is not to be construed as a propagating signal. Memory 304, as well as any computer-readable storage medium described herein, is to be construed as an article of manufacture.

Memory 304 may store any information utilized in conjunction with telecommunications. Depending upon the exact configuration or type of processor, memory 304 may include a volatile storage 314 (such as some types of RAM), a nonvolatile storage 316 (such as ROM, flash memory), or a combination thereof. Memory 304 may include additional storage (e.g., a removable storage 318 or a non-removable storage 320) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by network device 300. Memory 304 may comprise executable instructions that, when executed by processor 302, cause processor 302 to effectuate operations to map signal strengths in an area of interest.

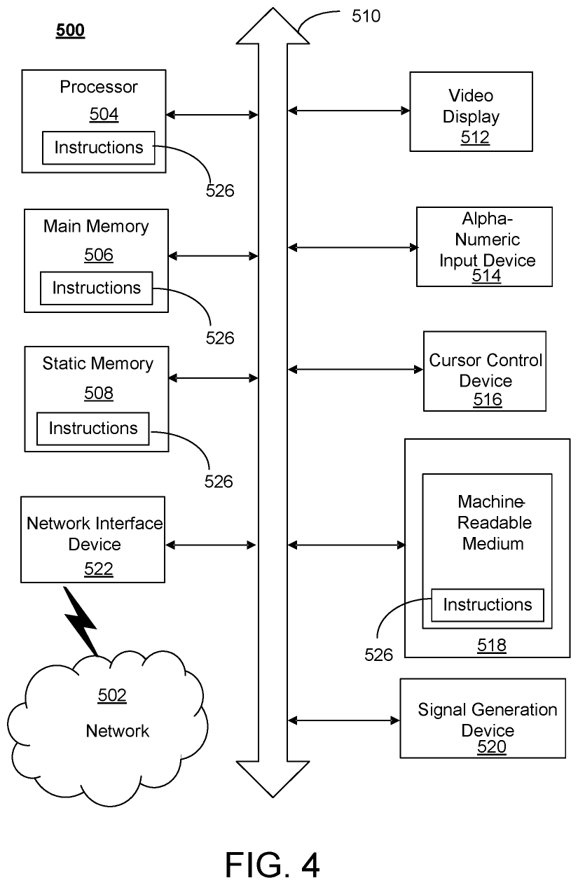

FIG. 4 depicts an exemplary diagrammatic representation of a machine in the form of a computer system 500 within which a set of instructions, when executed, may cause the machine to perform any one or more of the methods described above. One or more instances of the machine can operate, for example, as processor 302, UE 101, UE 201, and other devices of FIG. 1A or FIG. 1B. In some examples, the machine may be connected (e.g., using a network 502) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 500 may include a processor (or controller) 504 (e.g., a central processing unit (CPU)), a graphics processing unit (GPU, or both), a main memory 506 and a static memory 508, which communicate with each other via a bus 510. The computer system 500 may further include a display unit 512 (e.g., a liquid crystal display (LCD), a flat panel, or a solid state display). Computer system 500 may include an input device 514 (e.g., a keyboard), a cursor control device 516 (e.g., a mouse), a disk drive unit 518, a signal generation device 520 (e.g., a speaker or remote control) and a network interface device 522. In distributed environments, the examples described in the subject disclosure can be adapted to utilize multiple display units 512 controlled by two or more computer systems 500. In this configuration, presentations described by the subject disclosure may in part be shown in a first of display units 512, while the remaining portion is presented in a second of display units 512.

The disk drive unit 518 may include a tangible computer-readable storage medium on which is stored one or more sets of instructions (e.g., software 526) embodying any one or more of the methods or functions described herein, including those methods illustrated above. Instructions 526 may also reside, completely or at least partially, within main memory 506, static memory 508, or within processor 504 during execution thereof by the computer system 500. Main memory 506 and processor 504 also may constitute tangible computer-readable storage media.

As described herein, a telecommunications system may utilize a software defined network (SDN). SDN and a simple IP may be based, at least in part, on user equipment, that provide a wireless management and control framework that enables common wireless management and control, such as mobility management, radio resource management, QoS, load balancing, etc., across many wireless technologies, e.g. LTE, Wi-Fi, and future 5G access technologies; decoupling the mobility control from data planes to let them evolve and scale independently; reducing network state maintained in the network based on user equipment types to reduce network cost and allow massive scale; shortening cycle time and improving network upgradability; flexibility in creating end-to-end services based on types of user equipment and applications, thus improve customer experience; or improving user equipment power efficiency and battery life—especially for simple M2M devices—through enhanced wireless management.

While examples of a system in which D2D communication alerts can be processed and managed have been described in connection with various computing devices/processors, the underlying concepts may be applied to any computing device, processor, or system capable of facilitating a telecommunications system. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer-readable storage medium is not a propagating signal. A computer-readable storage medium as described herein is an article of manufacture. When the program code is loaded into and executed by a machine, such as a computer, the machine becomes a device for telecommunications. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language, and may be combined with hardware implementations.

The methods and devices associated with a telecommunications system as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes a device for implementing telecommunications as described herein. When implemented on a general-purpose processor, the program code combines with the processor to provide a unique device that operates to invoke the functionality of a telecommunications system.

While the disclosed systems have been described in connection with the various examples of the various figures, it is to be understood that other similar implementations may be used or modifications and additions may be made to the described examples of a telecommunications system without deviating therefrom. For example, one skilled in the art will recognize that a telecommunications system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure—D2D communication—as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

Methods, systems, and apparatuses, among other things, as described herein may provide for sending, by a first user equipment (UE), a discovery message to discover user equipment proximate to the first UE; receiving an authentication message from a second UE; determining there is a match for an International Mobile Subscriber Identity (IMSI) of the second UE with an inbound roam allowed IMSI list of the first UE; and based on the match, establishing a D2D communication link between the first UE and the second UE. The first UE and the second UE are with different WSPs which may operate on different bands. The D2D communication link may be a sidelink PC5. PC5 is a sidelink physical layer interface that may be used for D2D communication, such as UE-to-UE direct communication. The direct communication between vehicle and other devices (V2V, V2I) uses so-called PC5 interface. Using the disclosed subject matter with autonomous vehicles is contemplated herein. The method, system, computer readable storage medium, or apparatus provides for sending a response message to the authentication message based on the match, wherein the response message comprises an acknowledgement to the authentication message. The authentication message from the second UE may include MCC-MNC for the second UE among other information. The discovery message may be an Relay Discovery Additional Information (RDAI) message. The first UE and the second UE operate on different wireless service providers (e.g., different bands). The inbound roam allowed IMSI list or outbound roam allowed IMSI list may be periodically updated by a remote server. All combinations in this paragraph (including the removal or addition of steps) are contemplated in a manner that is consistent with the other portions of the detailed description.

What is claimed:

1. A method for device to device (D2D) roaming communication, the method comprising:
sending, by a first user equipment (UE), a discovery message to discover user equipment proximate to the first UE;
receiving an authentication message from a second UE proximate to the first UE;
based on the authentication message, determining there is a match for an International Mobile Subscriber Identity (IMSI) of the second UE with an inbound roam allowed IMSI list of the first UE; and
based on the match, establishing a D2D communication link between the first UE and the second UE.

2. The method of claim 1, wherein the D2D communication link is a sidelink PC5.

3. The method of claim 1, further comprising sending a response message to the authentication message based on the match, wherein the response message comprises an acknowledgement to the authentication message.

4. The method of claim 1, wherein the authentication message from the second UE comprises Mobile Country Code (MCC)-Mobile Network Code (MNC) for the second UE.

5. The method of claim 1, wherein the discovery message is a relay discovery additional information message.

6. The method of claim 1, wherein the first UE and the second UE operate on different wireless service providers.

7. The method of claim 1, wherein the inbound roam allowed IMSI list is periodically updated by a remote server.

8. A first user equipment comprising:
a processor; and
a memory coupled with the processor, the memory storing executable instructions that when executed by the processor cause the processor to effectuate operations comprising:
sending, by the first user equipment (UE), a discovery message to discover user equipment proximate to the first UE;
receiving an authentication message from a second UE proximate to the first UE;
based on the authentication message, determining there is a match for an International Mobile Subscriber Identity (IMSI) of the second UE with an inbound roam allowed IMSI list of the first UE; and
based on the match, establishing a D2D communication link between the first UE and the second UE.

9. The first user equipment of claim 8, wherein the D2D communication link is a sidelink PC5.

10. The first user equipment of claim 8, the operations further comprising sending a response message to the authentication message based on the match, wherein the response message comprises an acknowledgement to the authentication message.

11. The first user equipment of claim 8, wherein the authentication message from the second UE comprises Mobile Country Code (MCC)-Mobile Network Code (MNC) for the second UE.

12. The first user equipment of claim 8, wherein the discovery message is a relay discovery additional information message.

13. The first user equipment of claim 8, wherein the first UE and the second UE operate on different wireless service providers.

14. The first user equipment of claim 8, wherein the inbound roam allowed IMSI list is periodically updated by a remote server.

15. A computer readable storage medium storing computer executable instructions that when executed by a computing device cause said computing device to effectuate operations comprising:
sending, by a first user equipment (UE), a discovery message to discover user equipment proximate to the first UE;
receiving an authentication message from a second UE proximate to the first UE;
based on the authentication message, determining there is a match for an International Mobile Subscriber Identity (IMSI) of the second UE with an inbound roam allowed IMSI list of the first UE; and
based on the match, establishing a D2D communication link between the first UE and the second UE.

16. The computer readable storage medium of claim 15, wherein the D2D communication link is a sidelink PC5.

17. The computer readable storage medium of claim 15, the operations further comprising sending a response message to the authentication message based on the match, wherein the response message comprises an acknowledgement to the authentication message.

18. The computer readable storage medium of claim 15, wherein the authentication message from the second UE comprises Mobile Country Code (MCC)-Mobile Network Code (MNC) for the second UE.

19. The computer readable storage medium of claim 15, wherein the discovery message is a relay discovery additional information message.

20. The first user equipment of claim 8, wherein the inbound roam allowed IMSI list is periodically updated by a remote server.
